(19) United States
(12) Patent Application Publication
(10) Pub. No.: US 2013/0104796 A1
(43) Pub. Date: May 2, 2013

(54) SWALLOWING INDICATOR FOR SOLID OBJECTS

(71) Applicants: Nikhil Bhat, Fremont, CA (US); George Choi, Atherton, CA (US)

(72) Inventors: Nikhil Bhat, Fremont, CA (US); George Choi, Atherton, CA (US)

(21) Appl. No.: 13/665,856

(22) Filed: Oct. 31, 2012

Related U.S. Application Data
(60) Provisional application No. 61/553,956, filed on Nov. 1, 2011.

(51) Int. Cl. G01D 7/00; G01D 7/08; G01N 31/22

(52) U.S. Cl. 116/2; 116/200; 116/206; 116/201

(57) ABSTRACT

A method and apparatus related to a swallowing indicator for a solid object that is not intended to be ingested is disclosed. The indicator can be integrated with solid objects such as batteries or children's toys. The indicator stains the tongue, lips, or other areas of the mouth or throat when the object is swallowed, thus warning a caretaker. The indicator can be attached to or integrated with a solid object. The indicator may further comprise a bitterant.

### CROSS-REFERENCE TO RELATED APPLICATION(S)

This application claims priority under 35 U.S.C. §119(e) to U.S. Provisional Patent Application Ser. No. 61/553,956, “Swallowing indicator for substances and objects,” filed Nov. 1, 2011, which is incorporated by reference in its entirety.

### BACKGROUND OF THE INVENTION

1. Field of the Invention

The present invention relates generally to swallowing indicators and more specifically it relates to a swallowing indicator for that indicates that a solid object that is not intended to be ingested has been swallowed. More specifically, it relates to an indicator that stains the tongue, lips, or other areas of the mouth and throat when an object such as a battery or children's toy is swallowed.

2. Description of the Related Art

Swallowing solid objects that are not intended to be ingested is a problem, particularly for select populations including children, the elderly, and pets. This problem is compounded if the solid object that is swallowed contains battery acid, or other toxic or harmful materials.

Children frequently put non-edible solid objects into their mouths. Occasionally, this leads to swallowing of harmful objects, such as batteries. Timely discovery of solid objects that have been swallowed can prevent long term and potentially devastating effects on the body. In the past 10 years, the revolution in electronics has decreased the size and cost of batteries. Batteries are found in many consumer products such as remote controls, electronic toys, greeting cards, calculators, watches, thermometers, cameras, key chains, jewelry and clothing with blinking lights, and personal digital assistants. Other products such as hearing aids also have small button batteries. A recent study “Preventing Battery Ingestions: An Analysis of 8648 Cases” published in Pediatrics states that the annual incidence of battery ingestions reported to US poison centers from 1985 to 2009 fluctuated up and down between 6.3 and 15.1 cases per million people (most recently at 11.1 cases per million in 2009). The report stated that a 6.7-fold increase in the percentage of ingestions with major or fatal outcomes was observed during this period. The increase in severity was attributed to the emergence of the 20-mm-diameter lithium coin cell as an increasingly popular battery type. The lithium ion batteries generate external current, which can harm local tissue through a corrosive chemical process resulting from electrolysis and the production of hydroxide. Thirteen deaths related to tissue damage in the esophagus or airway and 73 major outcomes (with debilitating and prolonged compromise of feeding and/or breathing that required multiple surgical procedures, tube feedings, and/or tracheostomies) were reported in the study.

The risk of children and the elderly swallowing batteries is particularly concerning. The reports of serious events occurred predominantly in children who were younger than 4 years old. For the elderly, there is a risk of swallowing hearing aid batteries and other objects that are mistaken for pills due to poor vision. For pets, there is a risk of chewing on many small objects, such as television remote controllers, and swallowing components of these, such as batteries. In many cases, if a swallowing victim is not treated within less than 2 hours permanent damage can occur. If a victim's caregiver sees a victim swallow a battery, timely treatment can be administered to remove the battery and thus limit damage from the battery.

Even when a caregiver is able to take a patient to an emergency room, the cause of a swallowing victim's condition is often not readily apparent, which can lead to delays in providing treatment. If a victim's caregiver does not see the victim swallow a battery, then over the course of several hours, significant damage can occur to the esophagus or stomach, resulting in severe injury or death.

There is a need for an indicator which can be applied to any solid object, such as a battery, that is not intended to be ingested. This indicator can be designed to provide a visual feedback to the caregiver when the object to which this indicator is applied to is swallowed. This invention also discloses apparatus and methods of indicating swallowing of harmful objects.

### BRIEF SUMMARY OF THE INVENTION

The present invention overcomes the limitations of the prior art and current best practices by providing an indicator that is attached to a solid object that is not intended to be ingested and wherein the indicator stains the mouth or throat if the solid object is swallowed.

One objective of the invention is to provide a swallowing indicator that can be attached to any solid object, such as a battery or a children's toy. This indicator stains the tongue, lips, or other areas of the mouth or throat when the object is swallowed, thus warning the caretaker such that an appropriate treatment can be given.

The swallowing indicator can stain one or more of the tongue, lips, hard palate, soft palate, teeth, tonsils, or any other area of the mouth or throat to indicate that the solid object has been swallowed. Some embodiments enable selective staining of desired portions of the mouth or throat.

In some embodiments, the swallowing indicator can stain a surface in contact with saliva. In some embodiments, a portion of the indicator is released from the solid object in the presence of saliva to cause a stain on a surface that is in contact with the saliva.

The solid object can be a toy for a child.

A stain caused by the indicator on the mouth or throat may have characteristics that allow it to be distinguished from other stains. For example, the stain may be visible when illuminated with ultraviolet light in the wavelength range of 300 to 400 nanometers and not be visible when illuminated only with visible light (i.e., 400-700 nanometer wavelength light). The indicator can comprise a fluorescent material, such as a fluorescent dye.

The indicator can be designed such that a stain caused by the indicator on the mouth or throat is perceptible for at least 30 minutes and for no longer than 24 hours.

The indicator can be designed such that a stain caused by the indicator on the mouth or throat is perceptible for at least 8 hours.

The indicator can be selected such that a portion of the indicator is released from the solid object in the presence of water, saliva, or a substance above or below a pre-selected pH to cause a stain on the mouth or throat. Alternatively, the indicator can be selected such that a portion of the indicator reacts in the presence of water, saliva, or a substance that has a pH that is higher than or lower than a pre-selected pH to cause a stain on the mouth or throat.

The indicator can comprise a coating or a sticker that is adhered to the solid object. The indicator can comprise a coating that is applied as a paint, paste, liquid, or aerosol.

The indicator can comprise a bitterant.

The solid object can have a maximum dimension of 1 to 20 millimeters.

The indicator can comprise a substance that induces vomiting.

The indicator can be attached to the solid object by the manufacturer. Alternatively, the indicator can be sold separately from the solid object to be applied by a consumer to a selected solid object.

The indicator can be applied to the solid object during manufacturing of the solid object or after manufacturing of the solid object.

One objective of the invention is to provide a method for indicating that a solid object that is not intended to be ingested has been swallowed. This method can comprise the step of applying an indicator that stains the mouth or throat to the solid object that is not intended to be ingested. The indicator applied in this method may further comprise a bitterant.

Other objects and advantages of the present invention will be obvious to those skilled in the arts and it is intended that these objects and advantages are within the scope of the present invention.

### BRIEF DESCRIPTION OF THE DRAWINGS

Various other objects, features and attendant advantages of the present invention will become fully appreciated when considered in conjunction with the accompanying drawings, in which like reference characters designate the same or similar parts throughout the several views.

FIG. 1 is a top view of one embodiment of the invention. FIG. 1 illustrates an indicator attached to a solid object, such as a button battery.

FIG. 2 is a side view of one embodiment of the invention. FIG. 2 illustrates the layers of an exemplary indicator which can be applied to a battery or a child's toy. It consists of a peel off layer, an intermediate substrate with two-sided adhesive and a carrier layer embedded with a dye such as methylene blue or food coloring.

FIG. 3 is a schematic drawing of an aspect of an embodiment of the invention. In FIG. 3, the indicator comprises a dye and bitterant.

### DEFINITIONS

A “solid object not intended to be ingested” is a solid object that is not intended to be ingested and is not part of the delivery system for food. Examples of solid objects not intended to be ingested are batteries and interlocking building blocks (e.g., LEGO brand blocks). Examples of solid objects that are not considered in the definition of a solid object not intended to be ingested are popsicle sticks inside popsicles and forks.

A bitterant is a substance that is added to a product to make the product taste bitter. This bitter taste can be caused because the bitterant is bitter itself or by a reaction with another substance in the mouth or by a reaction with another substance in the product.

A dye is a material that is safe for ingestion and that stains the throat or mouth when in contact with the throat or mouth. Examples of dyes include methylene blue and food colorants. No distinction is made between dyes and inks.

### DETAILED DESCRIPTION OF THE INVENTION

Additional understanding of the invention, including particular aspects, embodiments, and advantages, will be apparent by referring to the detailed description below and to the drawings. The examples and embodiments presented herein are for illustrative purposes and are not intended to be limiting in scope. The invention is not limited in its application to the details of construction or to the arrangements of components set forth in the following description. The invention is capable of other embodiments and of being practiced and carried out in various ways.

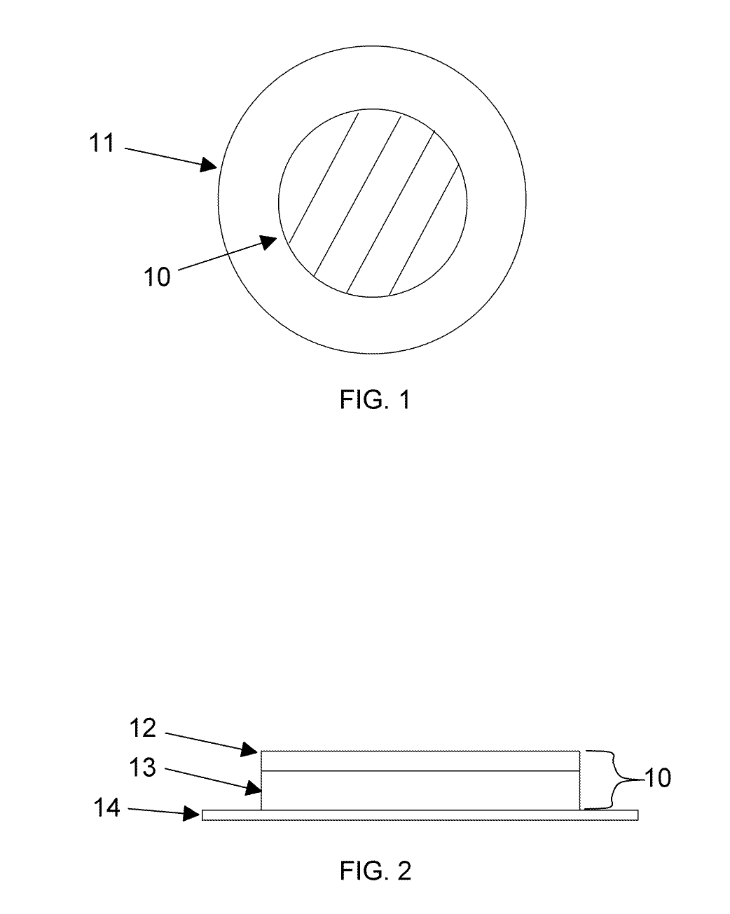

FIG. 1 illustrates an indicator 10 that can be attached or integrated with a solid object 11, such as a battery. The solid object 11 is an object that is not intended to be ingested, such as a button battery. Examples of potential forms for the indicator 10 include a sticker or a coating. The indicator 10 includes a dye that causes a visible stain on the mouth or throat of the person who swallows the solid object 11. The indicator 10 is mechanically attached to the solid object 11 and oriented such that if the solid object 11 is swallowed, the indicator will cause a stain to be formed on the mouth or throat.

In embodiments in which the indicator comprises a coating, the coating can be applied as a paint, paste, liquid, or aerosol. The coating can be deposited on the surface, can be electroplated, or can be applied by other means common in the art.

This visible stain caused by the dye typically remains visible for at least 30 minutes to safely warn the caregiver that a harmful substance has been swallowed. In many embodiments, the stain does not remain visible for more than 24 hours. Typically, dyes do not stain metallic substances like batteries easily. This can be beneficial when the dye is dispersed in a carrier media like blotting paper, rice paper or other absorbent materials which is edible and which can hold the dye effectively.

FIG. 2 illustrates one embodiment of the indicator 10, in which the indicator 10 can be applied to a solid object 11 as a sticker. In this embodiment, the indicator 10 comprises a carrier layer 12 and an adhesive backed sticker 13. The indicator 10 is attached to a peel off sheet 14. The carrier layer 12 is mechanically attached to the sticker 13 such that the carrier layer 12 is exposed to the mouth, throat, or saliva when the solid object 11 is swallowed. This embodiment can further comprise a peel-off sheet 14 that can be removed prior to application of the indicator 10 to the solid object 11.

One example of the sticker 13 is a silicone sticker which is stretchable and compressible. Typically the sticker 13 is applied to the top or bottom surface of the solid object 11. The sticker 13 can, however, be applied to any appropriate surface of the solid object 11.

The indicator 10 can be adapted based on the application. Typically, the indicator 10 does not significantly affect the functionality of the solid object 11. The indicator can be of any shape and size. For embodiments in which the solid object 11 is a button battery, the indicator 10 typically has a round or oval shape with a maximum diameter of 1 to 25 millimeters or 1 to 10 millimeters. The indicator 10 can withstand typical usage conditions for the solid object 11, such as operating temperature and storage temperature. The indicator 10 typically does not stain the hand of a person holding the solid object 11 when the hand is dry.

The indicator 10 can be configured to stain the hand of a person holding the solid object 11 when the hand is wet, such as with saliva. Other wet materials may also be stained when they come in contact with a similarly configured indicator 10 attached to a solid object 11.

The indicator 10 can be applied to a solid object 11 by removing the peel-off sheet 14 and attaching the sticker 13 to the solid object 11. If someone swallows the solid object 11, the indicator 10 leaves a stain on the tongue, lips, or any other part of the mouth or throat. It can also be used to stain any surface in contact with saliva. This stain stays for more than 30 minutes as much as 24 hours. So that when a caretaker sees the stain, they immediately are indicated of the swallowing of the battery and can take the swallowing victim to the emergency room immediately saving the victim's life.

The indicator 10 can be designed to stain selectively one or more areas of the mouth or throat, such as the tongue, lips, teeth, roof of the mouth, or tonsils. The indicator 10 can be designed to stain only the surface with which the indicator 10 comes into contact.

### Example 1

### Indicator Comprises Bitterant

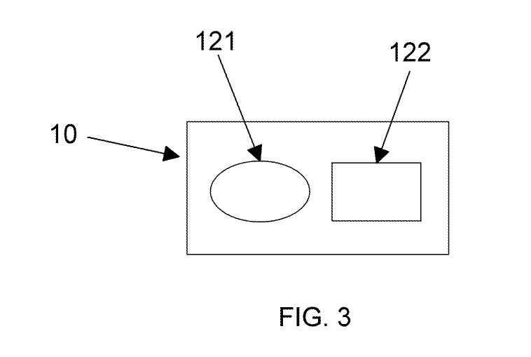

In some embodiments of the invention, the indicator 10 includes a bitterant 122 in addition to a dye 121, as illustrated in FIG. 3. In addition to causing a stain in the mouth or throat, this embodiment causes a bitter taste in the mouth when the solid object 11 is swallowed.

In some such embodiments, the bitterant 122 prevents a person from swallowing the solid object 11 by causing the potential swallowing victim to spit out the solid object 11 if he or she puts the solid object 11 in his or her mouth.

In some embodiments, such as the one illustrated in FIG. 2, the bitterant 122 and dye 121 are embedded in the carrier layer 12.

One or both of the dye 121 and the bitterant 122 can be activated or released by contact with saliva, by contact with body heat, or by a combination of contact with saliva and body heat.

The bitter taste caused by a bitterant causes an unpleasant taste and may induce the person swallowing the solid object to spit out the solid object. Examples of bitterants 122 include denatonium, sucrose octaacetate, quercetin, brucine, and quassin. Examples of organic bitterants 122 are Quassia Wood extract, Gentian Root extract, Areca catechu extract. An example of an artificial bitterent 122 is Bitrex®. The percentages of bitterant 122 to dye 121 can vary from 0.001:1 to 2:1.

### Example 2

### Gel or Powder Form of Indicator

In one embodiment, the dye is dispersed in a gel or powder form. For example, a gel or powder can be applied on the rim of a battery. This gel or powder indicator can be applied by the manufacturer or by the consumer.

### Example 3

### Indicator Comprises Two-Sided Tape with Edible Dissolving Substance

The indicator can comprise a piece of tape with both sides having adhesive layers such that one side attaches to an edible dissolving substance and the other side attaches to a solid object. The dissolving substance can include a dye or a bitterant such that when the object to which the sticker is attached is inserted into a person's mouth the dissolving substance releases a portion of the dye or bitterant, thus staining the mouth or throat or creating a bitter taste. Such tape can be made of silicone.

### Example 4

### Indicator Comprises Blotting Paper and Methylene Blue

The indicator can include a sticker to which is attached to a blotting paper, such as Asian rice paper. Such blotting paper can be impregnated with a dye, such as methylene blue, during manufacturing of the blotting paper or after manufacture. In the specific example of an indicator comprising methylene blue impregnated in Asian rice paper, the teeth are stained significantly in many embodiments with a dark blue color.

We claim:

1. An apparatus for indicating that a solid object has been swallowed comprising
a solid object that is not intended to be ingested and
an indicator that is attached to the solid object,
wherein the indicator stains the mouth or throat when the solid object is swallowed by a human.

2. An apparatus of claim 1, wherein the solid object is a battery.

3. An apparatus of claim 1, wherein the solid object is a toy for a child.

4. An apparatus of claim 1, wherein a stain caused on the mouth or throat by the indicator is not visible under illumination with light wavelengths in the range of 400 to 700 nanometers and the stain is visible under illumination with light wavelengths in the range of 300 to 400 nanometers.

5. An apparatus of claim 1, wherein a portion of the indicator is released from the solid object when placed in contact with water to cause a stain on the mouth or throat.

6. An apparatus of claim 1, wherein a portion of the indicator is released from the solid object when placed in contact with saliva to cause a stain on the mouth or throat.

7. An apparatus of claim 1, wherein a portion of the indicator is released from the solid object in the presence of a portion of saliva to cause a stain on a surface that is in contact with the portion of saliva.

8. An apparatus of claim 1, wherein a portion of the indicator reacts when placed in contact with water or saliva to cause a stain on the mouth or throat.

9. An apparatus of claim 1, wherein the indicator is released from the solid object in the presence of a substance that has a pH lower than a pre-selected pH threshold to cause a stain on the mouth or throat or wherein the indicator reacts with a substance that has a pH lower than a pre-selected pH threshold to cause a stain on the mouth or throat.

10. An apparatus of claim 1, wherein the indicator is released from the solid object in the presence of a substance that has a pH higher than a pre-selected pH threshold to cause a stain on the mouth or throat or wherein the indicator reacts with a substance that has a pH higher than a pre-selected pH threshold to cause a stain on the mouth or throat.

11. An apparatus of claim 1, wherein the indicator comprises a fluorescent material.

12. An apparatus of claim 1, wherein the indicator comprises a coating and wherein the coating is adhered to the solid object.

13. An apparatus of claim 1, wherein the indicator comprises a sticker and wherein the sticker is adhered to the solid object.

14. An apparatus of claim 1, wherein
the indicator comprises an adhesive layer and a dissolving layer,
wherein the adhesive layer mechanically attaches the indicator to the solid object and the dissolving layer comprises one or more of a dye and a bitterant, and
wherein a portion of the one or more of a dye and a bitterant are released when the solid object is swallowed.

15. An apparatus of claim 1, wherein the indicator further comprises a bitterant.

16. An apparatus of claim 1, wherein the indicator further comprises a material that induces vomiting.

17. An apparatus of claim 1, wherein the maximum dimension of the solid object is 1 to 20 millimeters.

18. A method for indicating that a solid object that is not intended to be ingested has been swallowed comprising the step of
applying an indicator that stains the mouth or throat to the solid object that is not intended to be ingested.

19. A method of claim 18, further comprising the step of
applying a bitterant to the solid object that is not intended to be ingested.

20. A method of claim 18, further comprising the step of
swallowing the solid object such that the indicator stains a portion of the mouth or throat.

21. An apparatus for indicating that a solid object has been swallowed comprising
an indicator designed to be attached to a solid object that is not intended to be ingested,
wherein the indicator stains the mouth or throat of a person who swallows the solid object.

22. An apparatus of claim 21, wherein
the indicator comprises a dye and a bitterant.

23. An apparatus of claim 21, wherein
the indicator comprises a sticker with an adhesive layer that can be attached to the solid object.
